(19) United States
(12) Patent Application Publication
(10) Pub. No.: US 2007/0226618 A1
(43) Pub. Date: Sep. 27, 2007

(54) Information Processing Device, Device Display Processing Method, And Storage Meidum

(75) Inventor: Takeshi Oya, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/681,888

(22) Filed: Mar. 5, 2007

(30) Foreign Application Priority Data
Mar. 23, 2006 (JP) 2006-080487

(51) Int. Cl. G06F 3/00

(52) U.S. Cl. 715/700

(57) ABSTRACT

An information processing device has: an acquisition unit to acquire integrated values indicating use states of devices respectively connected on a network; a calculation unit to calculate a reference value of the use states based on the plural integrated values acquired by the acquisition unit; and a control unit to cause a display unit to display the devices respectively corresponding to the integrated values not exceeding the reference value calculated by the calculation unit.

### BACKGROUND OF THE INVENTION

1. Field of the Invention

The present invention relates to a device display process which is to be executed in an information processing device for executing a search process to plural devices connected on a network.

2. Description of the Related Art

Conventionally, a network system in which plural devices, computers and servers are connected on a network is practically used. In the network system of this type, to search, list and display the computers and the image formation devices connected on the network is one of the functions to manage the devices connected on the network. Then, in a case where there are many searched devices, a method of narrowing down the searched devices on a specific condition is generally used.

As the method of narrowing down the searched devices, a method of narrowing down the searched devices by using MAC (Media Access Control) addresses each uniquely determined per each device connected on the network or IP (Internet Protocol) addresses each set with respect to one device connected on the network is generally adopted. Further, a method of narrowing down the search devices by using device type information capable of being acquired from an MIB (Management Information Base), maker information capable of being acquired from the MIB, and characteristics of products is generally adopted. Also, a method of displaying only the devices which respond to a protocol uniquely defined by a maker, a trader or the like is generally adopted.

Here, it should be noted that the MIB is used in a case where the devices are managed by an SNMP (Simple Network Management Protocol). According to the MIB, since a network management service to be used is different according to a kind of device and a kind of communication protocol, a unique object collection is provided for each service.

Further, as a method of searching a device based on an operating state, there is a method of comparing a list of last-time searched image formation devices with a list of this-time searched image formation devices and displaying only the devices not included in the list of last-time searched image formation devices (Japanese Patent Application Laid-Open No. 2002-157176).

Furthermore, there is a method of acquiring from each image formation device the total number of prints and its ability and narrowing down, based on the acquired data, the image formation devices according to frequencies in use and degrees of oldness of these devices (Japanese Patent Application Laid-Open No. H11-203092).

On the other hand, in case of newly setting up an image formation device, or in case of registering it to a monitoring device, it is necessary to search the relevant newly set-up image formation device.

In this case, it is difficult by the above-described conventional methods to effectively search the relevant newly set-up image formation device.

That is, in the method disclosed in Japanese Patent Application Laid-Open No. 2002-157176, in a case where the power source of the image formation device is once turned off after the last-time search and then turned on at the time of the this-time searching, the relevant image formation device is inevitably displayed on the list. Besides, in a case where searching is executed twice after a new image formation device was set, the relevant image formation device is not included in the list because it is not included in the list of last-time searched image formation devices.

Furthermore, in the method disclosed in Japanese Patent Application Laid-Open No. H11-203092, in a case where a highly functional image formation device of which the expected total number of output copies is, for example, 20,000,000 is set, then this device inevitably remains in the displayed list for a considerable period of time as compared with an image formation device of which the expected total number of output copies is about 200,000.

### SUMMARY OF THE INVENTION

The present invention has been completed in order to solve such conventional problems as described above. In this connection, an object of the present invention is to provide a mechanism capable of, based on use states of respective devices connected on a network, narrowing down the devices other than the devices of which the frequencies of use are relatively high on the network and then listing and displaying the narrowed-down devices.

That is, according to a first aspect of the present invention, there is provided an information processing device which comprises: an acquisition unit adapted to acquire integrated values indicating use states of devices respectively connected on a network; a calculation unit adapted to calculate a reference value of the use states based on the plural integrated values acquired by the acquisition unit; and a control unit adapted to cause a display unit to display the devices respectively corresponding to the integrated values not exceeding the reference value calculated by the calculation unit.

Further, according to a second aspect of the present invention, there is provided an information processing device which comprises: an acquisition unit adapted to search connection states of devices respectively connected on a network, and acquire from the respective devices information indicating use states of the respective devices; a selection unit adapted to evaluate the information of the respective devices acquired by the acquisition unit, and select the devices of which degrees of use are relatively low on the network; and a control unit adapted to cause a display unit to display the devices which were selected from all the devices on the network by the selection unit as the devices of which the degrees of use are relatively low.

Other features, objects and advantage of the present invention will be apparent from the following description when taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a view for describing a network system, to which an information processing device indicating the first exemplary embodiment of the present invention is applied.

FIG. 2 is a block diagram for describing the configuration of a program which operates on a host computer illustrated in FIG. 1 and searches for image formation devices.

FIG. 3 is a view illustrating an example of a device information table formed from information acquired by an information acquisition unit illustrated in FIG. 2.

FIG. 4 is a view illustrating an example of a counter information table, which is used for the calculation to be executed by a reference value (threshold) calculation unit illustrated in FIG. 2.

FIG. 5 is a flowchart illustrating an example of a data processing procedure carried out in the information processing device according to the present invention.

FIG. 6 is a block diagram for describing the constitution of the information processing device indicating the second exemplary embodiment of the present invention.

FIG. 7 is a view for describing a memory map of a storage medium for storing various data processing programs which can be read by the information processing device according to the present invention.

### DESCRIPTION OF THE EMBODIMENTS

Hereinafter, exemplary embodiments to carry out the present invention will now be described with reference to the accompanying drawings.

### Description of System Configuration

### First Exemplary Embodiment

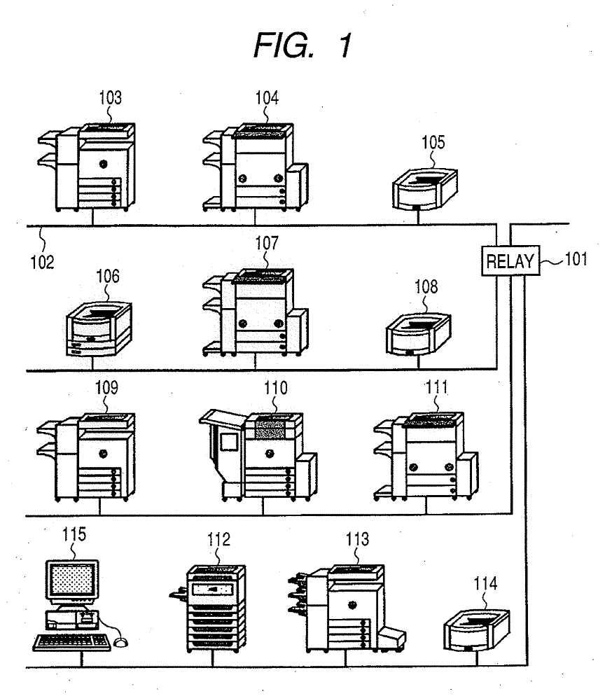

FIG. 1 is a view for describing a network system, to which an information processing device indicating the first exemplary embodiment of the present invention is applied.

In FIG. 1, a relay 101 called a router or a hub is used to connect networks each other. On a network 102, plural image processing devices, a network device (not illustrated) and a computer 115 which is functioning as an information processing device are connected to be able to communicate through the relay 101 with a predetermined protocol.

Image formation devices 103 to 114 are connected to a network. Here, a case that the respective image formation devices being constitutional factors are different each other is indicated. Of course, plural image formation devices having the same functions may be connected.

The computer 115 includes a controller unit, which has a CPU (Central Processing Unit), a ROM (Read Only Memory) and a RAM (Random Access Memory), and a keyboard and a pointing device as input devices. Further, a display device is connected to the computer as an output device. In addition, the computer 115, which includes an external storage device such as a hard disk, loads an installed OS (Operating System) into the RAM and executes various data processes by a process that the CPU executes various applications software. In addition, the computer 115, which includes a communication controller such as a network card, has a function of communicating with devices on the networks with plural protocols.

The computer 115 is constituted to be able to execute the Packet INternet Grouper (PING), which is a program of diagnosing a TCP/IP (Transmission Control Protocol/Internet Protocol) network such as an internet or an intranet, by the TCP/IP for example. The computer 115 designates an IP address of a network device such as a computer or an image formation device wanted to be checked if it is connected to the network. Further, the computer 115 includes a function, which diagnoses the network based on data indicating if a reply is sent from a network device of the other party and how long time is taken to receive the reply when it was sent by use of an ICMP (Internet Control Message Protocol) by transmitting, for example, data at the 32-byte level usually.

Further, the computer 115 includes a function of transmitting a ping command to a broadcast address for the destination of each image formation device connected to the network 102. Here, the broadcast address means a specific address used as the destination in a technique called a broadcast of transmitting one message to all terminals within a specific area on the network. The broadcast address is previously determined and provided every protocol to be used.

In a MAC (Media Access Control) address which is used in, for example, a LAN (Local Area Network), an address “FF:FF:FF:FF:FF:FF” is prepared as the broadcast address. Incidentally, in case of the IP address, an address “255.255.255.255” or an address given by setting all bits of the host portion to “1” is used.

For example, in a case that a network address is “128.1.0.0” and a host address corresponds to the low-order eight bits, the broadcast address becomes “128.1.255.255” (10000001.00000001.11111111.11111111).

Further, the computer 115 collects responses sent from the network devices on the network 102 by transmitting the ping command to the broadcast address. The computer 115 includes a function of displaying a list of the network devices, which were searched on the network 102, on a UI (User Interface) screen (not illustrated).

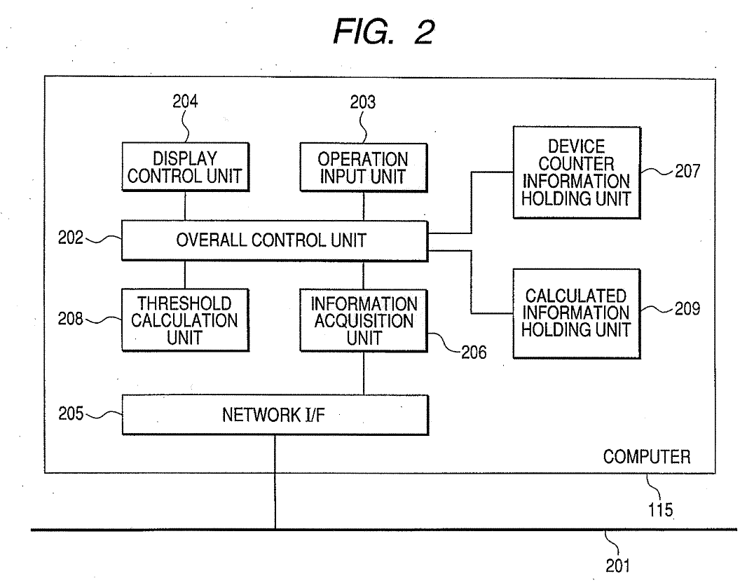

FIG. 2 is a block diagram for describing the configuration of a program which operates on a host computer 115 illustrated in FIG. 1 and searches for image formation devices.

In FIG. 2, a network 201 connects the respective image formation devices 103 to 114 with the computer 115.

An overall control unit 202 controls the whole of a searching process. An operation input unit 203 interprets an instruction as an input command upon receiving the instruction from the input devices (keyboard, pointing device) included in the computer 115. A display control unit 204 controls to display information on the display device included in the computer 115.

A network interface 205 communicates with the network devices on the network 201 with a predetermined protocol. An information acquisition unit 206 acquires counter information to be described later from the image information devices on the network. A device counter information holding unit 207 holds information such as a device name, an IP address and the counter information acquired by the information acquisition unit 206 as data of a table format.

A reference value (threshold) calculation unit 208 calculates a reference value from the information acquired by the information acquisition unit 206. A calculated information holding unit 209 holds calculated information after the calculation of the reference value performed by the reference value calculation unit 208. In the present exemplary embodiment, the reference value corresponds to, for example, a threshold which becomes the standard in selecting a device.

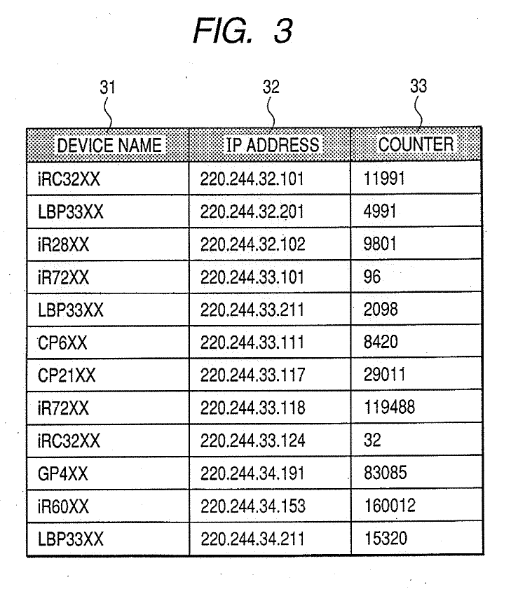

FIG. 3 is a view illustrating an example of a device information table formed from information acquired by the information acquisition unit 206 illustrated in FIG. 2. Acquisition timing of the information at the information acquisition unit 206 will be described later.

In FIG. 3, the device names represented by reference numeral 31 indicates the device names corresponding to the respective image formation devices 103 to 114 illustrated in FIG. 1. The device names can be displayed even if makers of the devices are different each other. The IP addresses are represented by reference numeral 32, to which IP addresses of the respective devices (which correspond to the image formation devices 103 to 114 illustrated in FIG. 1) corresponding to the device names 31 are set.

Information of counters is represented by reference numeral 33, to which counter information acquired from the respective devices are set. In the present exemplary embodiment, the maximum of counter number is “160012” corresponding to the name “iR60XX” of the device names 31. The minimum of counter number is “32” corresponding to the name “iRC32XX” of the device names 31.

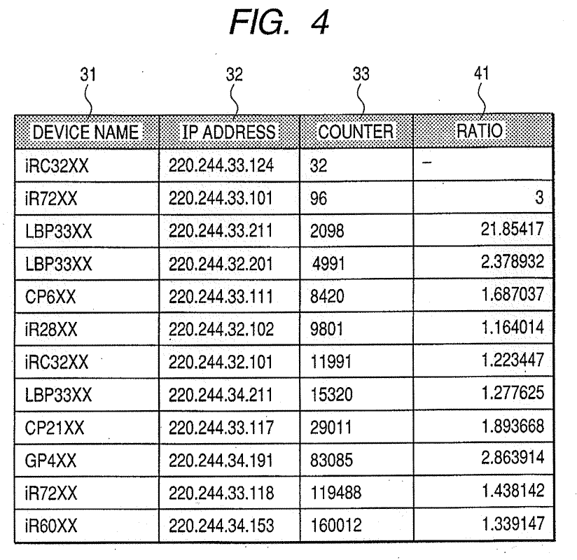

FIG. 4 is a view illustrating an example of a counter information table, which is used for the calculation to be executed by the reference value calculation unit 208 illustrated in FIG. 2. Note that the same items as those in FIG. 3 are denoted by the same reference numerals.

In FIG. 4, ratios represented by reference numeral 41 are calculated as described below. Namely, the counter information table illustrated in FIG. 4 is formed by the following procedure. That is, after sorting values indicated by the counter information 33 in the device information table illustrated in FIG. 3 in small order, the reference value calculation unit 208 successively calculates ratio between respective values in the counter information 33 of the respective devices. Concretely, a ratio between device names iRC32XX and iR772XX of the device names 31 becomes “3” from the calculation of 96/32. Similarly, as a result of calculating ratios, which are set as the ratios 41.

The reference value calculation unit 208 calculates a value “2098”, which is the value of the counter information 33 corresponding to the maximum value of the ratio, as a reference value. In an example illustrated in FIG. 4, a ratio “21.85417” of a device name “LBP33XX” is the maximum, and the value “2098” of the counter information 33 corresponding to that maximum ratio is calculated as the reference value.

The information processing device constituted as above has the following characteristic constitution.

The information processing device indicated in the present exemplary embodiment is constituted by the computer 115 which executes a searching process for the plural devices connected to the network 102 as illustrated in FIG. 1. Here, the plural devices are the image formation devices 103 to 114 illustrated in FIG. 1.

The information acquisition unit 206 has the acquisition function of acquiring integrated values indicating the use states of the respective devices from the respective devices on the network. The reference value calculation unit 208 has the calculation function of calculating a reference value of the use state based on the integrated value which was acquired by the information acquisition unit 206. Here, the reference value of the use state is such a reference value used for specifying a newly set device. A process of specifying a device corresponds to a process of selecting a device defined by information of the large different value based on, for example, a distribution of the number of prints of the searched devices. However, a relative use index of the device on the whole network is not limited to this case but information to be mentioned later can be also utilized.

The overall control unit 202 has a function of displaying a device, which indicates a integrated value of not exceeding the reference value to be calculated by the reference value calculation unit 208, on a display unit (not illustrated) through the display control unit 204.

With respect to the reference value to be calculated by the reference value calculation unit 208, the integrated values indicating the use states of the respective devices, for example, the counter information 33 corresponding to the number of prints of the image formation devices are sorted as indicated in FIG. 4. The reference value calculation unit 208 determines the maximum value of ratios, which are acquired by successively dividing the lower integrated value by the upper integrated value, as the use index of device. In an example illustrated in FIG. 4, the ratio “21.85417” of the device name “LBP33XX” is determined as the use index of device.

Since the each device can reset the integrated value, the overall control unit 202 executes the above process every reset.

The integrated value is count information counted according to execution of the function of the each device, and the integrated value may be, for example, the total operating time obtained by integrating the function executing time of the each device other than the information of the number of prints in the image formation device as above.

Furthermore, the device counter information holding unit 207, which holds information of the respective devices acquired by the information acquisition unit 206, is provided. Hereinafter, a concrete process of displaying a list of the devices will be described.

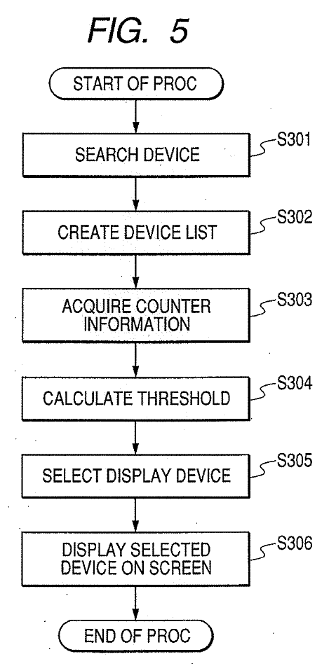

FIG. 5 is a flowchart illustrating an example of a data processing procedure carried out in the information processing device according to the present invention. This example is an example of a device search displaying process executed by the computer 115 illustrated in FIG. 1. Note that respective steps in the process are denoted by symbols S301 to S306. Each of the steps can be realized by executing a control program by the overall control unit 202 illustrated in FIG. 2.

First, when a searching process is started upon receiving an instruction from the operation input unit 203 illustrated in FIG. 2, the overall control unit 202 instructs the information acquisition unit 206 to detect the device and acquire the counter information from the detectable device. By this instruction, the information acquisition unit 206 searches for the devices on the network 201 and finds out the detectable device (step S301).

At this time, in the present exemplary embodiment, a method that the information acquisition unit 206 transmits a ping command to the above broadcast address is used.

Subsequently, in the step S302, acquisition of the counter information, which is held in a nonvolatile memory of the each device, is requested to the each device on the network 201 found out by the information acquisition unit 206 by utilizing an SNMP (Simple Network Management Protocol) (step S304).

The counter information held in the nonvolatile memory of the each device is acquired by the information acquisition unit 206 from the prtMarkerLifeCount object defined by the Printer-MIB (Management Information Base) (RFC (Request for Comments) 1759), for example.

Next, in the step S303, the overall control unit 202 forms a table for the device, from which the counter information indicated by the counter information 33 can be acquired, in the device counter information holding unit 207. The device, from which the counter information could not be acquired, is not set in the counter information 33 in the table.

An example of a table made to be held in the device counter information holding unit 207 after the overall control unit 202 formed the table according to this procedure is illustrated in FIG. 3.

In an example of the table illustrated in FIG. 3, as an example, the device names 33, the IP addresses 32 and the counter information 33 are held. The IP addresses 32 are information acquired in the step S302, and the device names 31 are information acquired together with the counter information 33 from each of the devices by the information acquisition unit 206 by using the SNMP in the step S303.

Subsequently, the overall control unit 202 sorts the respective values of the counter information 33 in the device counter information holding unit 207 in small order, and the reference value calculation unit 208 calculates a ratio between values of the counter information by dividing a next larger value by a previous smaller value but the minimum value is not used to be divided. Here, an example of the calculation result of ratios is indicated in a table illustrated in FIG. 4.

As illustrated in FIG. 4, the overall control unit 202 finds out a device of which the ratio 41 calculated from the counter information 33 in the present table becomes the maximum, and a counter value held by the device is assumed as a reference value. And, the devices, in which the counter information 33 indicating values less than that reference value is set, are selected as the devices targeted to display (step S305).

In an example illustrated in FIG. 4, the value “2098” of the counter information 33 held by the device of which the device name 31 is “LBP33XX” and the IP address 32 is “220.244.33.211” to be resulted in a ratio “21.8541” calculated by the reference value calculation unit 208 becomes the reference value.

The value “2098” of the counter information 33 is treated as the reference value, and devices to which values of the counter information 33 less than the reference value are set are targeted to display.

Concretely, a device of which the device name 31 is “iRC32XX” and the IP address 32 is “220.244.33.124” and a device of which the device name 31 is “iR72XX” and the IP address 32 is “220.244.33.101” are targeted to display.

Next, the devices selected to be displayed in the step S305 are displayed, for example, as a list on a display device (not illustrated) by a control of the display control unit 204 (step S306), thereafter the present process is terminated.

In the present exemplary embodiment, as a method of searching for the devices, a method of transmitting the ping command to the broadcast address has been used. However, a method of transmitting a request command to the broadcast address by a protocol of the SNMP can be used. Furthermore, a method of similarly performing the ping transmission or the SNMP transmission to the plural subnet addresses (not illustrated) held in the information acquisition unit 206 can be also used. Although a searching area differs, an object of searching for the devices can be achieved.

In the present exemplary embodiment, as a method of acquiring the counter information held by the each device on the network, the prtMarkerLifeCount defined by the Printer-MIB(RFC1759) is acquired.

However, the counter information can be also acquired by a method of acquiring the counter information from an object of a private MIB uniquely defined by a company or by a unique protocol, and an object of acquiring the counter information can be achieved.

In the present exemplary embodiment, although a calculation depending on the ratio is used as a calculation of determining the reference value, various calculations such as a calculation depending on difference, a calculation depending on a value having large difference between the value and a mean value and other calculations can be used. Furthermore, a predetermined value or a value designated by an input unit can be used as the reference value.

That is, in the present exemplary embodiment, as information of narrowing down the device newly set on the network, a small value in the total number of prints of the image formation device is used to narrow down the device.

Therefore, besides a method of utilizing the ratios and the maximum value of thereof described in the above first exemplary embodiment, there are a method (1) which utilizes the little order of the number of prints among the devices searched by utilizing values of average and distribution of the number of prints at a time of delivering the devices from a factory and a method (2) which utilizes a very different value based on distribution of the number of prints of the searched devices.

Furthermore, there is a method (3) of searching for the device which operates a short time after the image formation device starts up and a method (4) which utilizes information of the device of which the total operating time is short. Therefore, if it is information capable of specifying the newly set device, it is not limited to the method of narrowing down the device by the calculation of the ratios as above.

Furthermore, as the counter information to be collected from each of the devices on the network, the number of print sheets which can be reset may be used instead of the total number of prints.

Accordingly, the searching process, in a case that a user wants to search for an image formation device which is currently used as a new device or a used image formation device is newly set, can be executed.

Furthermore, the information to be collected from each of the devices on the network is not limited to the counter information, and even if the total operating time of the image formation device is used, the same effect can be obtained.

### Second Exemplary Embodiment

In the above first exemplary embodiment, there is a case that a device on the network 201 is once disconnected from the network in a state of turning on the power and then connected to the network again. In this case, when the counter information held in the device counter information holding unit 207 is relatively little, that information is targeted to display.

Consequently, in case of a system of registering the device, it may be constituted that a list of only the image formation devices which are not registered in the system and newly set is displayed by controlling to exclude the image formation devices already registered from targets to be searched. Hereinafter, the embodiment thereof will be described.

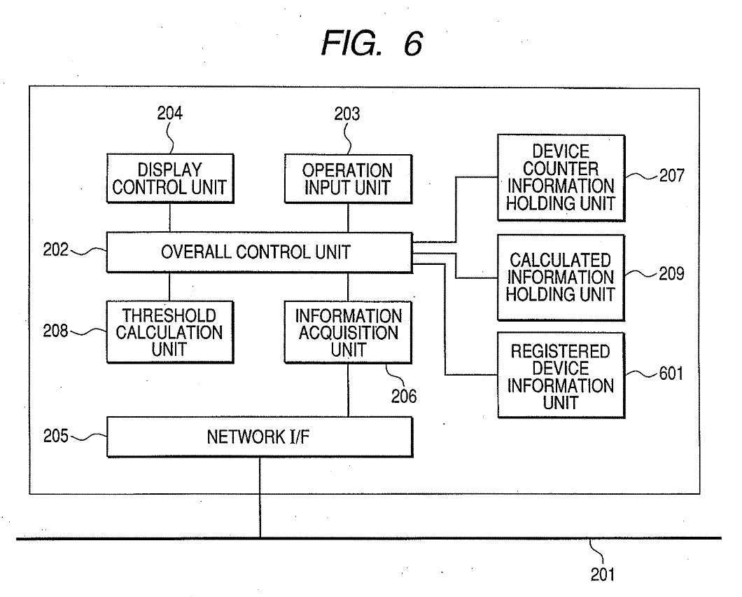

FIG. 6 is a block diagram for describing the constitution of an information processing device indicating the second exemplary embodiment of the present invention. Note that the same units as those in the first exemplary embodiment are denoted by the same reference numerals.

In FIG. 6, a registered device information unit 601 holds information of the registered devices.

In the present exemplary embodiment, the overall control unit 202 has a discrimination function of discriminating whether or not information of the device, which indicates an integrated value of not exceeding the reference value to be calculated by the reference value calculation unit 208, is already registered. The overall control unit 202 displays a device, which was discriminated as an unregistered device, on a display unit.

In each of the above exemplary embodiments, the devices are not limited to the image formation devices illustrated in FIG. 1, but may be input devices, output devices, input/output devices or combinations of these devices.

Hereinafter, an operation of the present exemplary embodiment will now be described with reference to a flowchart illustrated in FIG. 5.

In the step S301 indicated in FIG. 5, the overall control unit 202 gives a list of the IP addresses of the registered image formation devices acquired from the registered device information unit 601 to the information acquisition unit 206. At the same time, the overall control unit 202 instructs to acquire counter information of the image formation devices which can be detected and are not included in the list.

Then, the information acquisition unit 206 transmits a predetermined search packet to each of the devices on the network 201, searches for the devices from among responses from the respective devices and finds out the detectable image formation devices.

Among the detected image formation devices, the device which was registered in the registered device information unit 601 and has the coincident IP address is excluded from the devices targeted to display and then the counter information is continuously acquired.

As a result, information, which is formed based on the information acquired by the information acquisition unit 206 and held in the device counter information holding unit 207, does not contain information of the image formation device to be registered in the registered device information unit 601.

Accordingly, in the step S306 indicated in FIG. 5, information of the image formation device, which is not registered in the computer 115 and defined by the small total number of prints, is to be displayed in a list of the devices to be displayed on the display device.

In the present exemplary embodiment, a case of executing a process, where the registered image formation devices are excluded from the targets to be displayed in a list at the information acquisition unit 206, has been described.

However, even a method of excluding the image formation devices, of which information is stored in the registered device information unit 601, after forming a list for the image formation devices targeted to display based on the reference value calculated by the reference value calculation unit 208 can exhibit the same effect.

Accordingly, in case of a system for registering the devices, only the image formation devices which are not registered in the system and newly set can be displayed in a list by excluding the image formation device already registered from the targets to be searched.

### Third Exemplary Embodiment

In the above exemplary embodiments, as the devices on the network, a case that only the newly set devices are extracted to be displayed in a list after determining whether or not the devices are newly set on the network has been described by taking up an output device such as an image formation device as an example.

However, as the devices on the network, they are not limited to the output devices but may be network devices such as input devices or storage devices. As the contents of information to be acquired, it may be information which can determine a using condition such as the setting time of the device.

### Fourth Exemplary Embodiment

In the above exemplary embodiments, a case that only the new image formation devices searched on the network are displayed in a list has been described. However it may be constituted to print a list of the devices instead of the display of a list.

### Fifth Exemplary Embodiment

In an information processing device for processing network information while displaying icons of the devices on a network mapping diagram, it may be constituted to control that the newly set image formation devices searched on the network and other image formation devices are displayed by switching their display modes.

Accordingly, the displaying or printing of the device information taking the contrast between the newly set image formation devices and the previously set devices into consideration can be also carried out.

### Sixth Exemplary Embodiment

In the above exemplary embodiments, an example of the system, in which the computer 115 searches for each of the network devices, has been described.

As opposed to this system, it may be constituted that a server which executes the same functional processes as those in the computer 115 is connected to the network, and a process of calculating the reference value, a process of calculating the ratio and a process of determining the devices to be display are executed by the server, and information concerned those processes are held in a memory, and then information of a list of the devices are acquired by accessing to the server from another computer on the network to display the acquired information on a screen of the computer.

### Seventh Exemplary Embodiment

Furthermore, it may be constituted that a display control is performed in a manner that a mode of displaying a list of devices on a screen of the computer and a mode of displaying a list of devices, which are searched by the usual searching of the devices, are automatically switched after acquiring the information of a list of devices by accessing to the server from another computer on the network. According to this manner, the system conditions may be discriminatingly displayed by displaying that the device constitution of the whole network system is opposed to the device having information of a small counter value according to the use conditions.

### Eighth Exemplary Embodiment

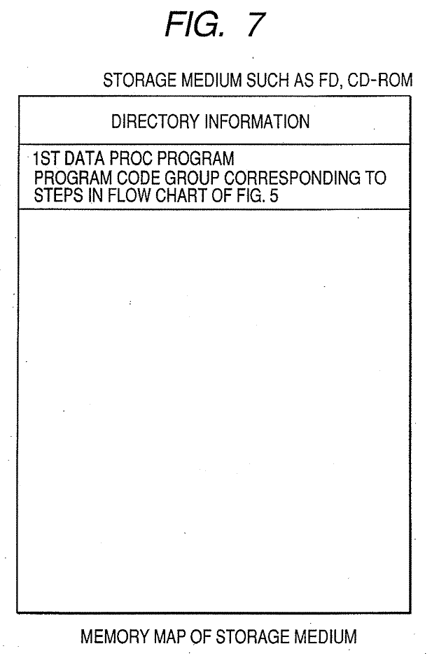

Hereinafter, the configuration of a data processing program which can be read by the information processing device according to the present invention will be described with reference to a memory map illustrated in FIG. 7.

FIG. 7 is a view for describing a memory map of a storage medium for storing various data processing programs which can be read by the information processing device according to the present invention.

Although not illustrated, there is also a case that information of managing program groups stored in the storage medium such as, for example, version information and information of a creator are stored and information which depends on an OS (Operating System) at a side of reading programs such as, for example, information of icons for discriminatingly displaying programs is stored.

Furthermore, data which belongs to various programs is also managed by the above-mentioned directory. There is also a case that a program for installing various programs into a computer and a program for executing extraction when a program to be installed is compressed are stored.

The function illustrated in FIG. 6 in the present exemplary embodiment may be performed by a host computer by using a program installed from the exterior. In this case, even if information groups which contain programs are supplied to the output device by the storage medium such as a CD-ROM, a flash memory or an FD, or from an external storage medium through the network, the present invention is applicable.

As above, a storage medium storing program codes of software for realizing the functions of the above-mentioned embodiments is supplied to a system or a device. It is needless to say that an object of the present invention can be achieved also in a case where a computer (or CPU or MPU) in the system or the device reads and executes the program codes stored in the storage medium.

In this case, the program codes themselves read from the storage medium realize the new functions of the present invention, and the storage medium storing such the program codes constitutes the present invention.

Therefore, any form of a program, such as an object code, a program executed by an interpreter or script data to be supplied to an OS is available without inquiring a program form if having the function of a program.

As the storage medium for supplying the programs, for example, a flexible disk, a hard disk, an optical disk, a magnetooptical disk, an MO, a CD-ROM, a CD-R, a CD-RW, a magnetic tape, a nonvolatile memory card, a ROM or a DVD can be used.

In this case, the program codes themselves read from the storage medium realize the functions of the above exemplary embodiments, and the storage medium storing such the program codes constitutes the present invention.

As another method of supplying the programs, there is a method of connecting to the homepage on an internet by using browser of a client computer. The programs can be also supplied by downloading the computer program itself of the present invention or a file which is compressed and includes an automatic installing function into a recording medium such as a hard disk from that homepage. Further, the supplying of the programs can be also realized by dividing program codes constituting the program of the present invention into plural files and downloading the respective files from different homepages. That is, a WWW server or a ftp (file transfer protocol), which makes users download program files for realizing the functional process of the present invention by the computer, is also included in appended claims of the present invention.

The programs of the present invention are encoded and stored into the storage medium such as CD-ROMs which are distributed to users, and key-information for solving the encoded program is made to be downloaded for the user who clears a predetermined condition from the homepage through the internet. And, the user executes the encoded program by using the key-information to install the program into the computer. Thereby the supplying of the program can be also realized.

It is needless to say that the present invention also includes not only a case where the functions of the above exemplary embodiments are realized by the execution of the program codes read by the computer, but also a case where, for example, an OS (Operating System) functioning on the computer executes all the process or a part thereof based on the instruction of the program codes, thereby realizing the functions of the above exemplary embodiments by that process.

Further, it is needless to say that the present invention also includes a case where the program codes read from the storage medium are written in a memory provided in a function expansion board inserted in the computer or a function expansion unit connected to the computer, and then a CPU provided in the function expansion board or the function expansion unit executes all the process or a part thereof based on the instruction of such the program codes, thereby realizing the functions of the above exemplary embodiments by that process.

The present invention is not limited to the above exemplary embodiments, but can be modified in various manners (including an organic combination of the respective embodiments) based on the spirit of the present invention, and the various modifications are not excluded from the scope of the present invention.

Although various samples and embodiments of the present invention have been indicated and described, the spirit and scope of the present invention are not limited to a specific description in the present specifications for the person skilled in the art.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent constitutions and functions.

This application claims the benefit of Japanese Patent Application No. 2006-080487, filed on Mar. 23, 2006, which is hereby incorporated by reference herein in its entirety.

What is claimed is:

1. An information processing device comprising:
an acquisition unit adapted to acquire integrated values indicating use states of devices respectively connected on a network;
a calculation unit adapted to calculate a reference value of the use states based on the plural integrated values acquired by the acquisition unit; and
a control unit adapted to cause a display unit to display the devices respectively corresponding to the integrated values not exceeding the reference value calculated by the calculation unit.

2. An information processing device according to claim 1, wherein the reference value of the use state is a maximum value of ratios which are acquired by sorting in order the integrated values indicating the use states of the respective devices and successively dividing the lower integrated values by the upper integrated values.

3. An information processing device according to claim 1, wherein each device can reset the integrated value.

4. An information processing device according to claim 1, wherein the integrated value is equivalent to count information counted according to execution of a function of each device.

5. An information processing device according to claim 1, wherein the integrated value is equivalent to a total operating time which is acquired by integrating operating times of the respective devices.

6. An information processing device according to claim 1, further comprising:
a holding unit adapted to hold information of each device acquired by the acquisition unit; and
a determination unit adapted to determine whether or not the information of the device corresponding to the integrated value not exceeding the reference value calculated by the calculation unit has been registered in the holding unit,
wherein the control unit causes the display unit to display the device which has been determined by the determination unit to be not registered in the holding unit.

7. An information processing device according to claim 1, wherein the devices includes an input device, an output device and an input/output device.

8. A device display processing method which is adapted to an information processing device, the method comprising steps of:
acquiring integrated values indicating use states of devices respectively connected on a network;
calculating a reference value of the use states based on the integrated values acquired in the acquiring step; and
causing a display unit to display the devices respectively corresponding to the integrated values not exceeding the reference value calculated in the calculating step.

9. A computer-readable storage medium which stores therein a program to cause a computer to execute following steps of
acquiring integrated values indicating use states of devices respectively connected on a network;
calculating a reference value of the use states based on the integrated values acquired in the acquiring step; and
causing a display unit to display the devices respectively corresponding to the integrated values not exceeding the reference value calculated in the calculating step.

10. An information processing device comprising:
an acquisition unit adapted to search connection states of devices respectively connected on a network, and acquire from the respective devices information indicating use states of the respective devices;
a selection unit adapted to evaluate the information of the respective devices acquired by the acquisition unit, and select the devices of which degrees of use are relatively low on the network; and
a control unit adapted to cause a display unit to display the devices which were selected from all the devices on the network by the selection unit as the devices of which the degrees of use are relatively low.
